(19) United States
(12) Patent Application Publication
(10) Pub. No.: US 2013/0001458 A1
(43) Pub. Date: Jan. 3, 2013

(54) TANK DUMP VALVE

(75) Inventor: Jacques Tremblay, Toronto (CA)

(73) Assignee: Hutchinson Industries Canada Inc., Toronto (CA)

(21) Appl. No.: 13/368,890

(22) Filed: Feb. 8, 2012

(30) Foreign Application Priority Data
Jun. 30, 2011 (CA) 2744771

(51) Int. Cl. F16K 31/00

(52) U.S. Cl. 251/341

(57) ABSTRACT

This invention relates to a dump valve for a liquid retaining tank having an outlet with a valve seat disposed over the outlet and a valve member displaceable between an open position spaced from the valve to release the liquid from the tank and a closed position for contacting the valve seat to seal the outlet, with an actuator to move the valve member between the open and closed positions. The valve member includes spaced upper and lower plates with deformable material there between to contact the valve seat. The upper plate also including stopper pins.

FIELD OF INVENTION

This invention relates to a dump valve for a liquid retaining tank having a valve member moveable between an open and closed position relative to the valve seat; the valve member including spaced upper and lower plates for securing deformable material therebetween, and stopper pins extending from the upper plate. The invention also relates to the method for retaining and dispensing liquid from a tank.

### BACKGROUND TO THE INVENTION.

There are many tanker cars which are being used to transport fluids. The tanker cars arc moved by vehicles such as trains on rails or trucks from one location to the other. The tank generally has an outlet at the bottom thereof with an inlet at the top of the tank for receiving fluids.

The outlet is generally defined by a flange which defines a generally circular valve seat which valve seat is disposed at an acute angle relative to the axis of the outlet. A valve member generally includes a conical surface which engages the valve seat and is actuated by a threaded rod extending from the top surface of the tank to the outlet so that it can be manipulated to open and close the valve in a manner well known to those persons skilled in the art.

There have been many attempts in the prior art to design dump valves which are easy to manufacture and use so as to open and close the outlet in an efficient manner. For example, U.S. Pat. No. 1,890,247 relates to a valve mechanism for tank cars, in a combination which comprises an elongated operating rod provided with structure adjacent its upper end for rotating the rod where the rod is of sufficient length to project from the dome of the car into proximity to a valve scat located in the bottom of the tank car.

Moreover, U.S. Pat. No. 2,139,280 relates to a discharge valve for containers comprising a valve cage adapted to be secured to a container and formed with outlet ports and a valve seat, a cap secured to the cage; and extending upwardly therefrom a valve element slidingly mounted within the cage, a valve stem projecting from the element and guided by the cap, with operating structure for the valve clement threadably engaged with the valve stem whereby rotation thereof will raise and lower the valve element and sealing means between the cap and operating means and between the valve stem and cap thereby preventing ingress of material from the container.

Yet another top operated tank car valve is disclosed in U.S. Pat. No. 4,240,607.

Moreover U.S. Pat. No. 4,264,053 also relates to a top operating outlet valve with unitary closure guide and retainer.

Furthermore U.S. Pat. No. 4,338,689 relates to a self-aligning valve assembly and valve plug which includes an elastomeric valve plug have an annular outer sealing portion with an annular sealing surface for sealing a drain hole valve seating of a receptacle.

Furthermore, U.S. Pat. No. 5,076,539 relates to a bottom outlet valve for a tank on a vehicle especially for a railway tank car.

Yet another arrangement is shown in U.S. Pat. No. 5,244,181 which relates to a high-flow internal emergency valve.

Finally, Canadian Patent No. 2,316,589 relates to a dump valve for a liquid retaining tank with an outlet position on the bottom of the tank where a valve member is moveable between a closed position engaging a valve seat and an open position spaced from the valve seat where the valve member has a depending truncated conical deformable engagement surface secured to the valve member solely from above where the depending truncated conical deformable engagement surface has inwardly tapered sidewalls adapted to mate with the inwardly tapered sidewalls of the valve seat and deform around debris to form a liquid retaining seal notwithstanding the presence of the debris.

It is an object of this invention to provide an improved dump valve and method of utilizing same.

It is an aspect of this invention to provide a dump valve for a liquid retaining tank having an outlet, comprising: a valve seat disposed over the outlet; valve structure displaceable between: an open position space from the valve seat for releasing the liquid from the tank; and a closed position for contacting the valve scat to seal the outlet; an actuator to move the valve means between the open and closed positions. In one embodiment the valve structure comprises an upper plate and a lower plate spaced from said upper plate and deformable material disposed between the upper and lower plates, the deformable material spaced from the valve seat in the open position and contacting the valve seat in the closed position. The deformable material secured between the upper and lower plates. In another embodiment the upper plates includes stopper pins.

It is another aspect of the invention to provide A dump valve for a liquid retaining tank having an outlet, comprising: a valve seat defining an outlet; a valve member concentrically disposed about the valve seat for movement along an axis between: an open position spaced from the valve seat for releasing the liquid from the tank through the outlet, and an closed position to contact the valve seat to seal the outlet; an actuator for moving the valve member between the open and closed positions; the valve member including spaced upper and lower plates with displaceable material there between for contacting the valve seat.

Yet another aspect of this invention relates to a dump valve for a liquid retaining tank having an outlet, comprising: a valve seat defining an outlet; a valve member concentrically disposed about the valve seat for movement along an axis between: an open position space from the valve seat for releasing the liquid from the tank through the outlet; and a closed position to contact the valve seat to seal the outlet; an actuator to move the valve member between the open and closed positions; the valve member including spaced upper and lower plates with rubber material there between, the upper plate including the stopper means. In one embodiment the stopper means comprise stopper pins extending from the upper plate.

These and other features and objects of the invention shall now be described in relation to the following drawings

### DESCRIPTION OF DRAWINGS

FIG. 1 is a perspective view of the dump valve taken from the side.

FIG. 2 is a top plan view of the dump valve.

FIG. 3 is a cross-sectional view of the dump valve taken from the view of 3-3 of FIG. 2.

FIG. 4 is a top perspective view of the valve member.

FIG. 5 is an enlarged view of Detail B of FIG. 3.

FIG. 6 is a side perspective view of the upper plate of the valve member.

FIG. 7 is a side view of the upper plate of the valve member.

FIG. 8 is a perspective view of the deformable material.

FIG. 9 is a side view of the deformable material.

FIG. 10 is a side perspective view of the dump valve assembly.

FIG. 11 is a side perspective view of FIG. 10.

FIG. 12 is an enlarged view of one end of the actuator.

### DETAILED DESCRIPTION OF THE INVENTION

Like parts have been given like numbers throughout the figures.

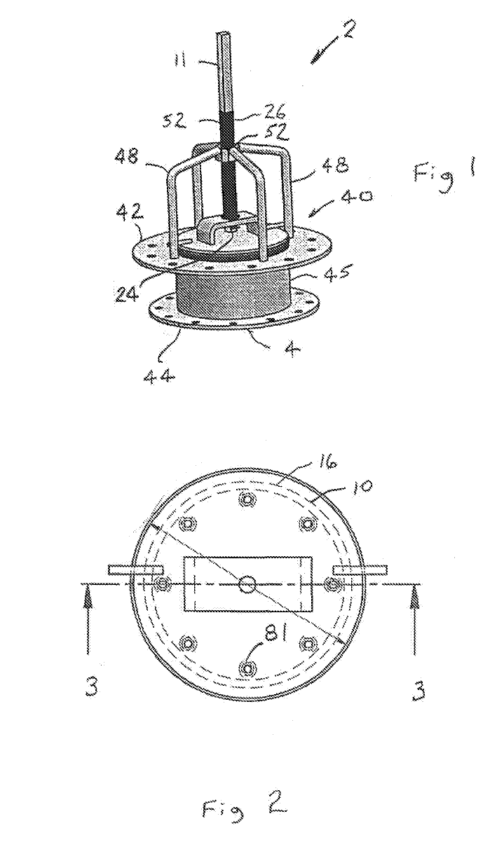

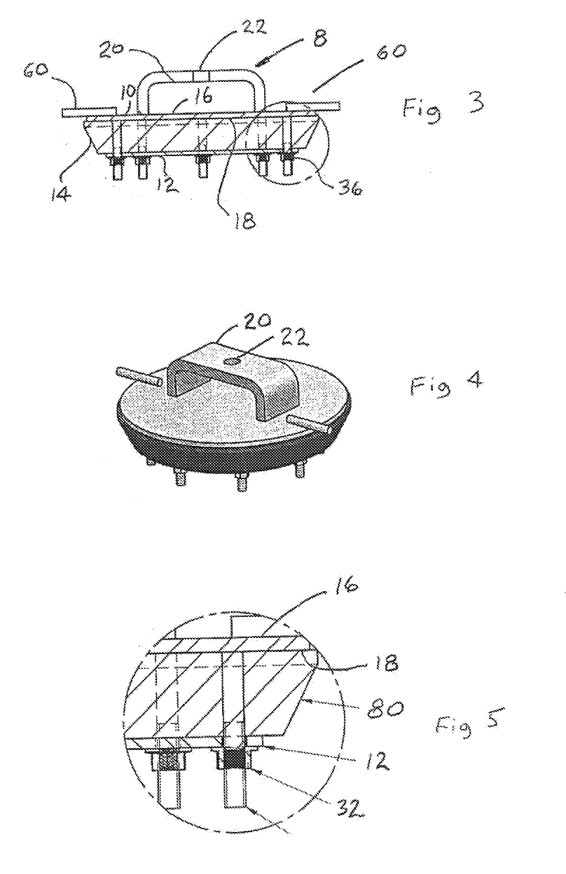

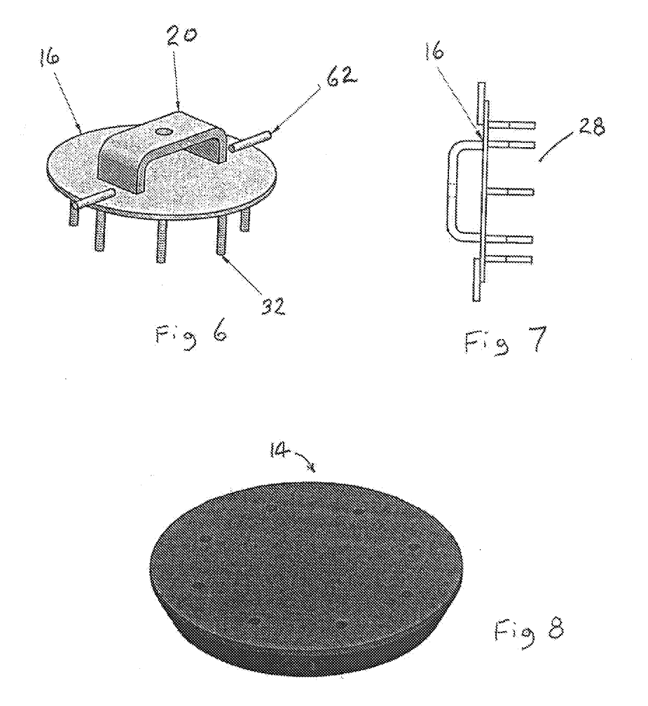

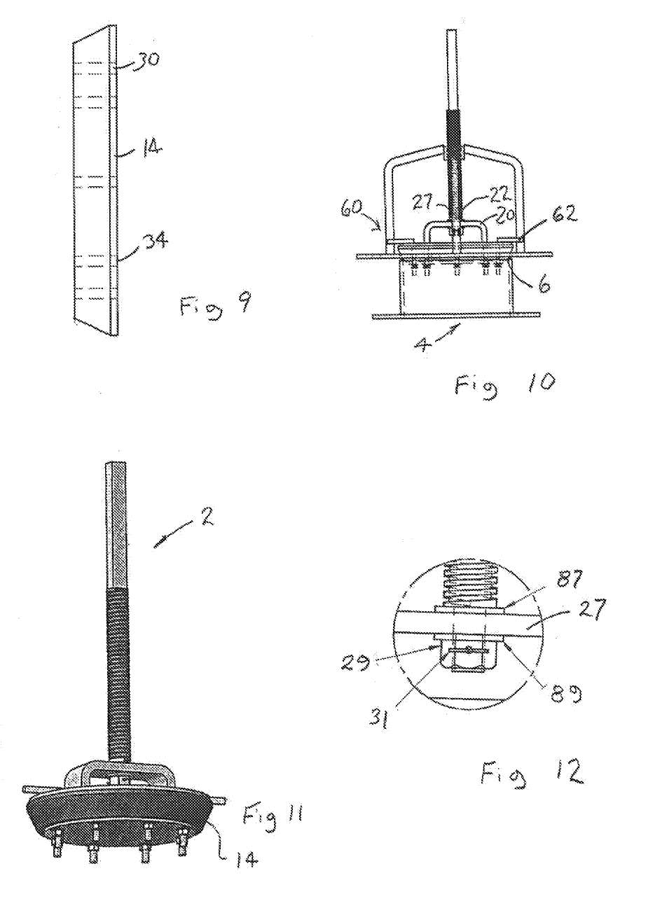

FIG. 1 illustrates a dump valve 2 for a liquid retaining tank (not shown) having an outlet 4 with a valve seat 6 disposed over the outlet 4.

The dump valve 2 also includes valve means 8 displaceable between an open position spaced from the valve seat 6 for releasing the liquid from the tank (not shown), and a closed position for contacting the valve seat 6 to seal the outlet 4. The dump valve 2 also includes an actuator 10 to move the valve means 8 between the open and closed position.

The valve means 8 comprises an upper plate 10 which as shown comprises a circular plate as well as a circular lower plate 12 which is spaced from the upper plate 10 with deformable material 14 disposed between the upper plate 10 and lower plate 12. The circular lower plate 12, deformable material 14 and lower plate are co axially disposed relative one another.

In one embodiment the upper and lower plates 10 and 12 are comprised of a steel plate which depending on the liquid could be stainless steel, steel, metal, plastic or the like while the deformable material 14 in one embodiment comprises rubber. The rubber 14 comprises of material which is compatible with the liquid that is being stored in the tank.

The upper plate 10 has a top surface 16 and a bottom surface 18. The top surface 16 of the upper plate 10 engages the actuator 11. In particular the top surface 16 of the upper plate 10 engages a U-shaped bracket 20 which has a hole 22 disposed therein adapted to receive one end 24 of a threaded rod 26. The one end 24 also has an unthreaded portion 27 and a threaded nut 29 adapted to receive a cotter pin 31 that passes through the diameter of the rod 26 as shown so that the actuator 11 can spin relative to the bracket 20.

The bottom surface 18 of the upper plate 10 includes at least one fastening means 28 where the deformable material 14 includes passage means 30 for receiving the fastening means 28 there through where the fastening means 28 engages the lower plate 12.

In particular the fastening means 28 comprises a plurality of bolts 32 depending from the bottom surface 18 of the upper plate 10. The plurality of bolts 32 can be welded to the bottom surface 18 of the upper plate 10 in a manner well known to those persons skilled in the art or fastened thereto by some other means. The deformable material 14 as well as the lower plate 12 includes a plurality of aligned holes 34 for receiving the plurality of bolts 32 respectively and a plurality of nuts 36 for engaging the plurality of bolts 32.

The outlet 4 is defined by a flange 40. In particular the flange 40 comprises an upper flange disk 42 spaced from a lower flange disk 44 with a flange disk 46 connected thereto by a collar 45 by any number of means including welding which defines a flange output.

The upper flange disk 42 includes a cage 48 connected thereto which embodiment as shown in FIG. 1 comprises four bent fingers having one end connected to the upper surface of the upper flange disk 42 by any variety of means including welding while the other end of the four bent fingers terminates at a central threaded member which is adapted to receive a threaded link 52 of the threaded rod 26. The cage 48 is utilized so as to assist in the alignment of the dump valve 2.

The flange 40 includes the cage 48 for receiving the upper plate 10 as well as the lower plate 12 and deformable material 14 within the confines of the cage 48 as shown on FIG. 1.

The upper plate 10 includes alignment means 60 for alignment with the cage 48. In particular the alignment means 60 comprises protrusions 62 which are in close proximity to at least one of the fingers 48 as shown in FIG. 1. In another embodiment the protrusions 62 contact the cage fingers 48. The embodiment as shown in the drawings illustrate the protrusions 62 to one side of a pair of opposed fingers 48 although the fingers can be disposed to be on alternate sides of opposing fingers 48.

The protrusions 62 comprise stopper pins which are adapted to contact the fingers 48 and prevent the valve from spinning. In other words if the actuator 11 is rotated clockwise or counter clockwise the pin 62 prevents or stops the valve means 8 from spinning without advancing or retracting from the valve seat 4; as the pin 62 will contact the finger 48. Furthermore the outside diameter of the upper disc 10 is larger than the outer diameter of the lower disc 12. The outer diameter of the upper and lower disc are smaller than the inside spacing of the cage or fingers 48, as there is a space between the outside diameter of the disc 10 and the fingers 48. In other words the outer diameter of the upper disc 10 is spaced from the cage 48. The pins 62 assist in aligning the valve means 8 relative to the cage 48; since the pins 62 will minimize the “wandering off centre” of the valve within the confines of the cage 48.

The invention as described herein relates to the dump valve 2 for a liquid retaining tank (not shown) which has an outlet 4. The valve seat 6 defines the outlet 4. The valve member 8 is concentrically disposed about the valve scat 6 along an axis 70 between an open position spaced from the valve seat 6 for sealing the liquid from the tank (not shown) through the outlet 4; and a closed position to contact the valve seat 6 to seal the outlet 4.

The actuator 11 moves the valve member 8 between the open and closed positions.

The valve seat 6 is defined by the flange 40 and further includes the cage 48 attached to the upper surface of the top flange disk 42.

The deformable material 14 includes a sealing surface 80 to contact the valve seat 6. The fastening means 32 is concentrically disposed about the axis along a pitch circle 81 and spaced from the sealing surface 80. The valve seat 6 and the sealing surface 80 are angled and as shown are angled at an acute angle relative to the axis 70. Furthermore the fastening means 16 is disposed along a pitch circle 81 or radius from the axis 70 which is less than the radius of the angled sealing surface 80 so that the fastening means 60 does not interfere in any way with the sealing surface 80 of the valve. In other words the sealing surface 80 is intact as the sealing surface is spaced radially outwardly from the fastening means 28, and the upper and lower plates 10 and 12 sealingly fastened to resilient material 14.

Moreover the valve member 8 includes spaced upper and lower plates with rubber material there between. And the upper plate 10 includes stopper pins 60.

The holes shown in the upper flange disc 42 and lower flange disc 44 arc used to attach the dump valve to a tank in a manner well known to persons skilled in the art.

Although the preferred embodiment as well as the operation and use have been specifically described in relation to the drawings, it should be understood that variations of the preferred embodiments can be achieved by a person skilled in the trade without departing from the spirit of the invention as claimed herein.

1. A dump valve for a liquid retaining tank having an outlet, comprising:
a) a valve seat disposed over the outlet;
b) a valve means displaceable between:
i) an open position space from the valve scat for releasing the liquid from the tank;
ii) a closed position for contacting the valve seat to seal the outlet;
c) an actuator to move the valve means between the open and closed positions.

2. A dump valve as claimed in claim 1 wherein said valve means comprise an upper plate and a lower plate spaced from said upper plate and deformable material disposed between the upper and lower plates, the deformable material spaced from the valve seat in the open position and contacting the valve seat in the closed position.

3. A dump valve as claimed in claim 2 wherein the upper plate has a top and bottom surface and the top surface of the upper plate engages the actuator.

4. A dump valve as claimed in claim 3 wherein the bottom surface of the upper plate includes at least one fastening means, the deformable material including a passage for receiving the fastening means there through, such fastening means engaging said lower plate.

5. A dump valve as claimed in claim 4 wherein the fastening means comprises a plurality of bolts depending from the bottom surface of the upper plate, the deformable material and lower plate including a plurality of aligned holes there through for receiving the plurality of bolts respectively and a plurality of nuts for engaging the plurality of bolts.

6. A dump valve as claimed in claim 5 wherein the outlet is defined by a flange.

7. A dump valve as claimed in claim 6 wherein the flange includes a cage for receiving the upper plate.

8. A dump valve as claimed in claim 7 wherein the upper plate includes aligning means for aligning the upper plate with the cage.

9. A dump valve as claimed in claim 8 wherein the aligning means comprises protrusions extending from the upper surface to engage the cage.

10. A dump valve as claimed in claim 9 wherein the protrusions comprise stopper pins.

11. A dump valve for a liquid retaining tank having an outlet, comprising:
a) a valve seat defining an outlet;
b) a valve member concentrically disposed about the valve seat for movement along an axis between:
i) an open position spaced from the valve seat for releasing the liquid from the tank through the outlet, and
ii) an closed position to contact the valve scat to seal the outlet;
c) an actuator for moving the valve member between the open and closed positions;
d) the valve member including spaced upper and lower plates with displaceable material there between for contacting the valve seat.

12. A dump valve as claimed in claim 11 wherein the upper plate has a top and bottom surface and the top surface includes a bracket for engaging the actuator.

13. A dump valve as claimed in claim 12 wherein the valve seat is defined by a flange, and further includes a cage attached to the flange.

14. A dump valve as claimed in claim 13 wherein the fastening means extends from the upper plate through the deformable material and engageable with the lower plate wherein the upper and lower plates secure the deformable material there between.

15. A dump valve as claimed in claim 14 wherein the deformable material includes a surface for contacting the valve seat.

16. A dump valve as claimed in claim 15 wherein the fastening means are concentrically disposed about the axis and spaced from the surface for contacting the valve seat.

17. A dump valve as claimed in claim 16 wherein the valve seat and the surface arc angled.

18. A dump valve as claimed in claim 17 wherein the fastening means are disposed along a radius from the axis which is less than the radius of the surface for contacting the valve seat.

19. A dump valve for a liquid retaining tank having an outlet, comprising:
a) a valve scat defining an outlet;
b) a valve member concentrically disposed about the valve scat for movement along an axis between:
i) an open position space from the valve seat for releasing the liquid from the tank through the outlet; and
ii) a closed position to contact the valve seat to seal the outlet.
c) an actuator to move the valve member between the open and closed positions;
d) the valve member including spaced upper and lower plates with rubber material there between, the upper plate including the stopper means.

20. A dump valve as claimed in claim 19 wherein such stopper means comprise stopper pins extending from the upper plate.
